(19) United States
(12) Patent Application Publication
(10) Pub. No.: US 2021/0394593 A1
(43) Pub. Date: Dec. 23, 2021

(54) VEHICLE WINDOW SHADE ASSEMBLY AND METHOD

(71) Applicant: Owen Benson, Folsom, CA (US)

(72) Inventor: Owen Benson, Folsom, CA (US)

(21) Appl. No.: 16/903,994

(22) Filed: Jun. 17, 2020

(51) Int. Cl. B60J 3/02; B60J 1/20

(52) U.S. Cl. CPC B60J 3/0286; B60J 1/2011

(57) ABSTRACT

A vehicle window shade assembly includes panel cut into a shape of a vehicle window. The panel is flexible and opaque. The panel has a first side, a second side and a perimeter edge. The second side has a plurality of suction cups extending away therefrom. The suction cups are arranged in a grid pattern of columns and rows forming a plurality of rectangular sections. The suction cups are attached to an interior surface of the vehicle window.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to window shade device and more particularly pertains to a new window shade device for blocking light from entering a vehicle through a window.

### (2) Description of Related Art Including Information Disclosed Under 37 CFR 1.97 and 1.98

The prior art relates to window shade devices that are used in vehicles to shade the occupants from sunlight.

### BRIEF SUMMARY OF THE INVENTION

An embodiment of the disclosure meets the needs presented above by generally comprising a panel cut into a shape of a vehicle window. The panel is flexible and opaque. The panel has a first side, a second side and a perimeter edge. The second side has a plurality of suction cups extending away therefrom. The suction cups are arranged in a grid pattern of columns and rows forming a plurality of rectangular sections. The suction cups are configured to be attached to an interior surface of the vehicle window.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a vehicle window shade assembly and method according to an embodiment of the disclosure.

FIG. 2 is a rear view of an embodiment of the disclosure.

FIG. 3 is an enlarged view of area “3” of FIG. 2 of an embodiment of the disclosure.

FIG. 4 is a cross-sectional view of an embodiment of the disclosure taken along line 4-4 of FIG. 3.

FIG. 5 is a front isometric view of an embodiment of the disclosure.

### DETAILED DESCRIPTION OF THE INVENTION

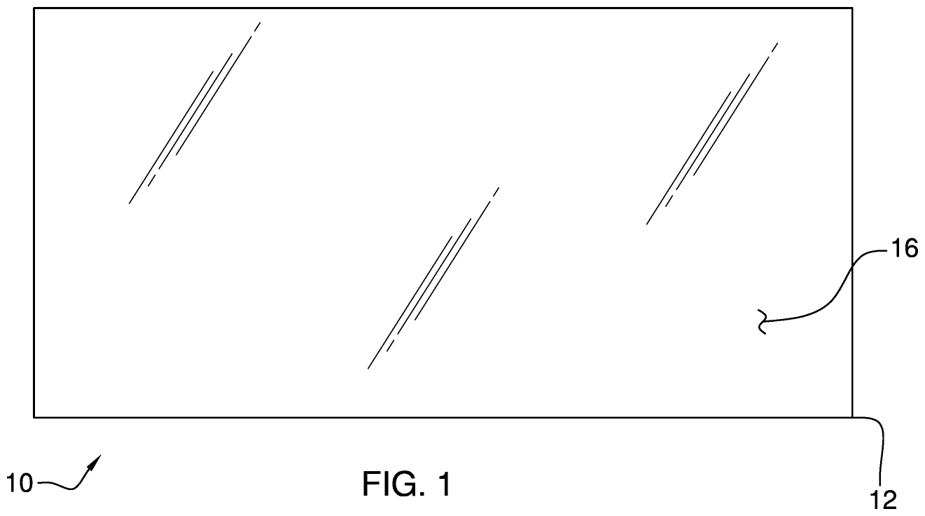

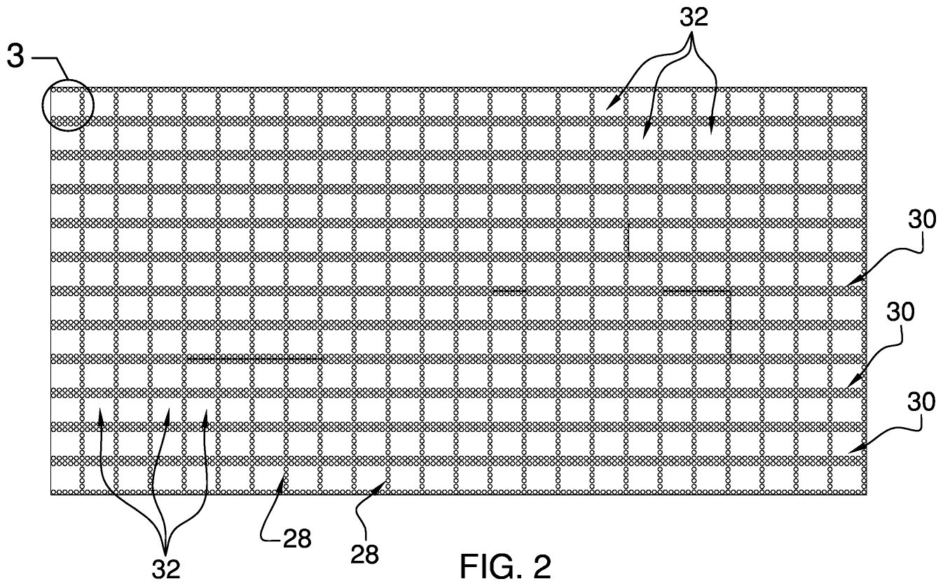

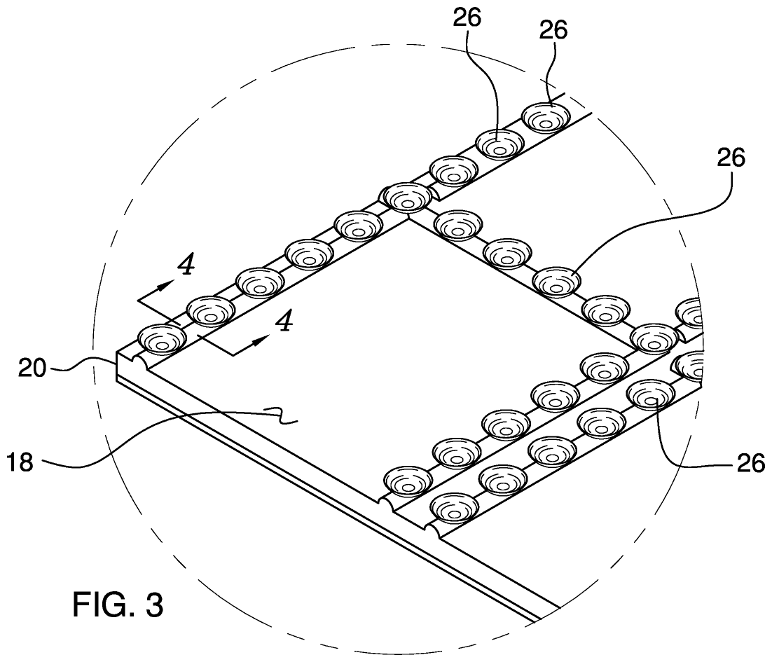

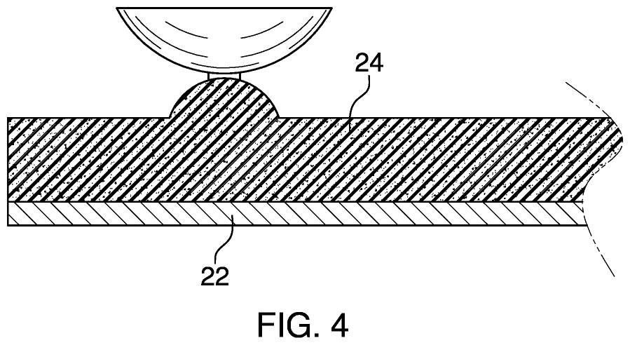

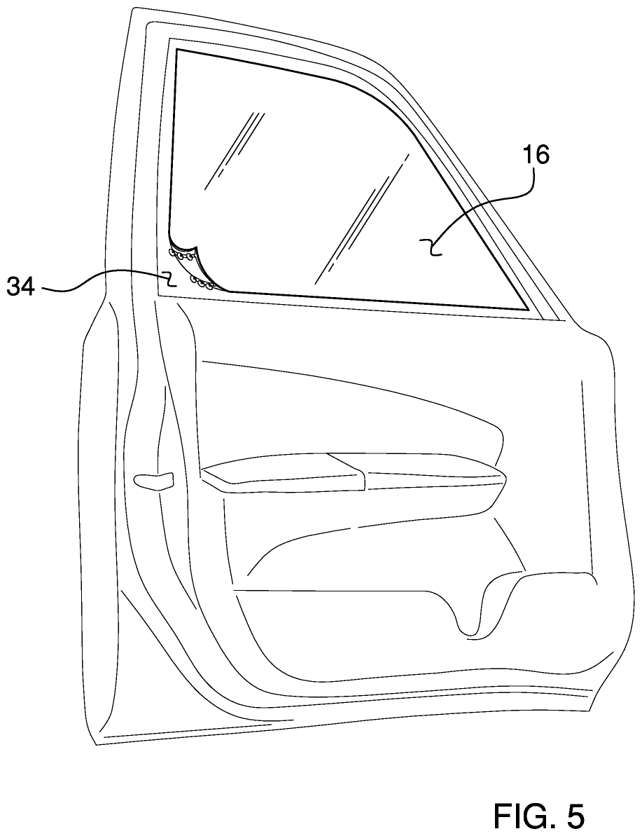

With reference now to the drawings, and in particular to FIGS. 1 through 5 thereof, a new window shade device embodying the principles and concepts of an embodiment of the disclosure and generally designated by the reference numeral 10 will be described.

As best illustrated in FIGS. 1 through 5, the vehicle window shade assembly 10 and method generally comprises cutting a panel 12 into a shape of a vehicle window 34. The panel 12 is flexible and opaque and may include a plurality of layers. The panel 12 has a first side 16, a second side 18 and a perimeter edge 20. The first side 16 may be a layer 22 comprised of a polyester film such as biaxially-oriented polyethylene terephthalate, commercially known as Mylar. This layer 22 functions as an insulation and as a reflective material to reduce heat transmission through the panel 12. The second side 18 may be comprised of an elastomeric or silicone material layer 24 which is highly flexible. The panel 12 has a thickness of less than 0.50 inches and more particularly less than 0.25 inches.

The second side 24 has a plurality of suction cups 26 extending away therefrom. The suction cups 26 are arranged in a grid pattern of columns 28 and rows 30 forming a plurality of rectangular sections 32. The section cups 26 are relatively small and each has a diameter that is no greater than 0.60 inches and in some embodiments is equal to about 0.50 inches. The rows 30 are spaced from each other a distance of between 3.0 inches and 5.0 inches and the columns 28 are spaced from each other a distance of between 3.0 inches and 5.0 inches. Each of the sections 32 includes at least twelve of the suction cups 26.

In use, the panel 12 is provided in a size that is larger than the window 34 on which it will be applied. The panel 12 is therefore cut to the shape matching the window 34. The grid pattern of the suction cups 26 ensures that the there are enough attachment points for the panel 12 regardless of the window 34 size and shape. The suction cups 26 are attached to an interior surface of the vehicle window 34 to prevent light from entering the vehicle through the vehicle window 34. The suction cups 26 allow the panel 12 to be removed when not needed and reattached as the need arises.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A window covering assembly configured to cover a vehicle window to prevent light from entering a vehicle through the vehicle window, said assembly comprising:
a panel having a shape of a vehicle window, said panel being flexible and opaque, said panel having a first side, a second side and a perimeter edge, said second side having a plurality of suction cups extending away therefrom, said suction cups being arranged in a grid pattern of columns and rows forming a plurality of rectangular sections; and
wherein said suction cups are configured to be attached to an interior surface of the vehicle window.

2. The window covering assembly according to claim 1, wherein each of said suction cups has a diameter being no greater than 0.60 inches.

3. The window covering assembly according to claim 2, wherein said rows are spaced from each other a distance of between 3.0 inches and 5.0 inches, said columns being spaced from each other a distance of between 3.0 inches and 5.0 inches.

4. The window covering assembly according to claim 3, wherein each of said sections includes at least twelve of said suction cups.

5. The window covering assembly according to claim 1, wherein each of said sections includes at least twelve of said suction cups.

6. A method of blocking light through vehicle window, said method including the steps of:
cutting a panel into a shape of a vehicle window, said panel being flexible and opaque, said panel having a first side, a second side and a perimeter edge, said second side having a plurality of suction cups extending away therefrom, said suction cups being arranged in a grid pattern of columns and rows forming a plurality of rectangular sections, each of said suction cups having a diameter being no greater than 0.60 inches, said rows being spaced from each other a distance of between 3.0 inches and 5.0 inches, said columns being spaced from each other a distance of between 3.0 inches and 5.0 inches, each of said sections including at least twelve of said suction cups; and
attaching said suction cups to an interior surface of the vehicle window.
